(19) United States
(12) Patent Application Publication
(10) Pub. No.: US 2010/0246725 A1
(43) Pub. Date: Sep. 30, 2010

(54) Selective diversity receiving method and apparatus

(75) Inventors: Kazunori Okuyama, Kanagawa (JP); Hideo Tsutsui, Kyoto (JP); Kiyohito Tokuda, Saitama (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 12/656,265

(22) Filed: Jan. 22, 2010

(30) Foreign Application Priority Data
Mar. 25, 2009 (JP) 2009-073771

(51) Int. Cl. H04B 1/10; H04B 17/00; H04L 27/06

(52) U.S. Cl. 375/340; 455/226.1; 375/346

(57) ABSTRACT

In a selective diversity receiver with two antennas, the strength of the signal received by each antenna is measured at a present and a past time, the difference between the present strengths of the signals received by the two antennas is calculated, and the difference between the present and past strengths of the signal received by each antenna is calculated. If the difference between the present strengths of the two signals is not too large, the signal with the smaller past-to-present strength difference and accordingly with less fading is selected for further reception. In a portable electronic device, this antenna switching strategy reduces susceptibility to human body interference. The present and past strengths can be measured during the preambles of different packets to avoid switching antennas during data reception.

### BACKGROUND OF THE INVENTION

1. Field of the Invention

The present invention relates to a selective diversity receiving method and apparatus that provide improved resistance to fading and do not require antenna switching during data reception.

2. Description of the Related Art

High-frequency radio signals possess strong directionality, which affects portable electronic devices that communicate in high frequency bands. When such a portable electronic device is worn on or placed in close proximity to the body of the user, for example, the user's body may block the propagation channel of the signal to be received, increasing the channel loss and impairing communication quality.

In Japanese Patent Application Publication No. 2006-319731, Nakamura describes a method of circumventing human body interference by providing an extra antenna built embedded in a neckstrap worn around the user's neck. When the neckstrap antenna is connected to the portable electronic device, channel loss due to human body interference is reduced and receiving sensitivity is improved.

Human body interference also aggravates the common problem of multipath fading, because when an antenna is affected by human body interference, much of its received signal power comes from reflected propagation paths. While an antenna unaffected by human body interference experiences only weak fading, and its received signal power varies only gradually, an antenna affected by human body interference can experience strong fading, with large and rapid variations in received power.

In Japanese Patent Application Publication No. H06-311146, Iwai et al. describe a method of receiving radio signals in a multipath fading environment by selective diversity, that is, by selective use of the signals received by two or more antennas. The described method extracts the clock frequency components of the signals received by the antennas, compares their strengths, and selects the antenna receiving the strongest clock frequency component for further signal reception. This method reduces thermal noise errors due to flat fading and inter-code interference errors due to frequency-selective fading, but since the antenna receiving the strongest clock frequency component is selected every time the clock frequency components are compared, antenna switching occurs frequently, with attendant demodulation bit errors due to electrical noise caused by the antenna switching.

When a phase modulation scheme such as phase shift keying (PSK) is used, a further problem is that the signals received by different antennas vary independently in phase, due to a combination of different propagation path length differences, different fading patterns, and different noise characteristics. Whenever the antennas are switched, accordingly, the phase relationships of the received signal change, causing additional demodulation bit errors.

The portable electronic device shown by Nakamura has a whip antenna and an internal antenna, which could be used together with the neckstrap antenna for selective diversity reception, but Nakamura does not describe a selective diversity reception method.

### SUMMARY OF THE INVENTION

The invention provides a receiving method employing a first antenna, a second antenna, and a selector. The first antenna receives a transmitted signal and outputs a first received signal. The second antenna receives the same transmitted signal and outputs a second received signal. The selector selects the first received signal and/or the second received signal and outputs the selected signal(s). The two antennas are spatially separated. The method includes the steps of:

selecting a first timing interval and a second timing interval in the transmitted signal, the second timing interval preceding the first timing interval;

measuring the received signal strength of the first received signal in the first timing interval to obtain a first received signal strength, and in the second timing interval to obtain a first past received signal strength;

measuring the received signal strength of the second received signal in the first timing interval to obtain a second received signal strength, and in the second timing interval to obtain a second past received signal strength;

calculating a difference between the first received signal strength and the first past received signal strength to obtain a first difference;

calculating a difference between the second received signal strength and the second past received signal strength to obtain a second difference; and

generating a switching signal that controls the selector according to the first received signal strength, the second received signal strength, the first difference, and the second difference.

More specifically, the switching signal may be generated from the first difference, the second difference, a third difference obtained by subtracting the second received signal strength from the first received signal strength, and a fourth difference obtained by, subtracting the absolute value of the second difference from the absolute value of the first difference. If the absolute value of the third difference exceeds a threshold value, the antenna is selected according to the sign of the third difference; the antenna with the stronger received signal is elected. If the absolute value of the third difference is less than the threshold value, the antenna is selected according to the sign of the fourth difference; the antenna with less past-to-present change in received signal strength is selected.

This method is resistant to fading because it considers not only the present signal strengths, but also the difference between the present and past received signal strengths. Use of this method can make a portable electronic device less susceptible to human body interference.

The method does not require a circuit for extracting a clock frequency component.

If the transmitted signal is a packet signal including a preamble and a payload, the first and second timing intervals can be placed in the preambles of different packets to avoid switching antennas during reception of the payload data, thereby reducing the occurrence of bit errors in the received data.

The invention also provides a receiving apparatus employing the above method.

### BRIEF DESCRIPTION OF THE DRAWINGS

In the attached drawings:

FIG. 1 shows an external view of a portable electronic device with a receiving apparatus embodying the invention;

FIG. 2 is an internal block diagram of the portable electronic device in FIG. 1;

FIG. 3 is a more detailed block diagram of the antenna selector and switching controller in FIG. 2;

FIG. 4 is a more detailed block diagram of the switching signal generator in FIG. 3;

FIG. 5 illustrates propagation paths of a radio signal transmitted from a vehicle to the portable electronic device;

FIG. 6 schematically illustrates the structure of a packet and the intervals in which received signal strength is detected;

FIG. 7 illustrates some of the values calculated during antenna selection;

FIG. 8 illustrates the setting of a threshold value corresponding to a target packet error rate; and

FIG. 9 is a flowchart illustrating the switching control process.

### DETAILED DESCRIPTION OF THE INVENTION

An embodiment of the invention will now be described with reference to the attached drawings, in which like elements are indicated by like reference characters. The description will begin with a description of a portable electronic device including a receiving apparatus embodying the invention, and then proceed to a more detailed description of the receiving apparatus.

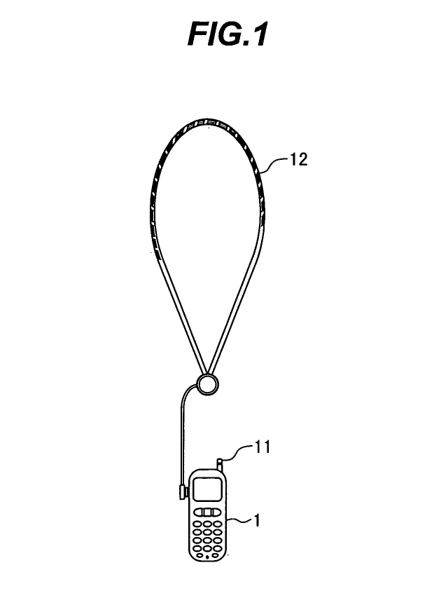

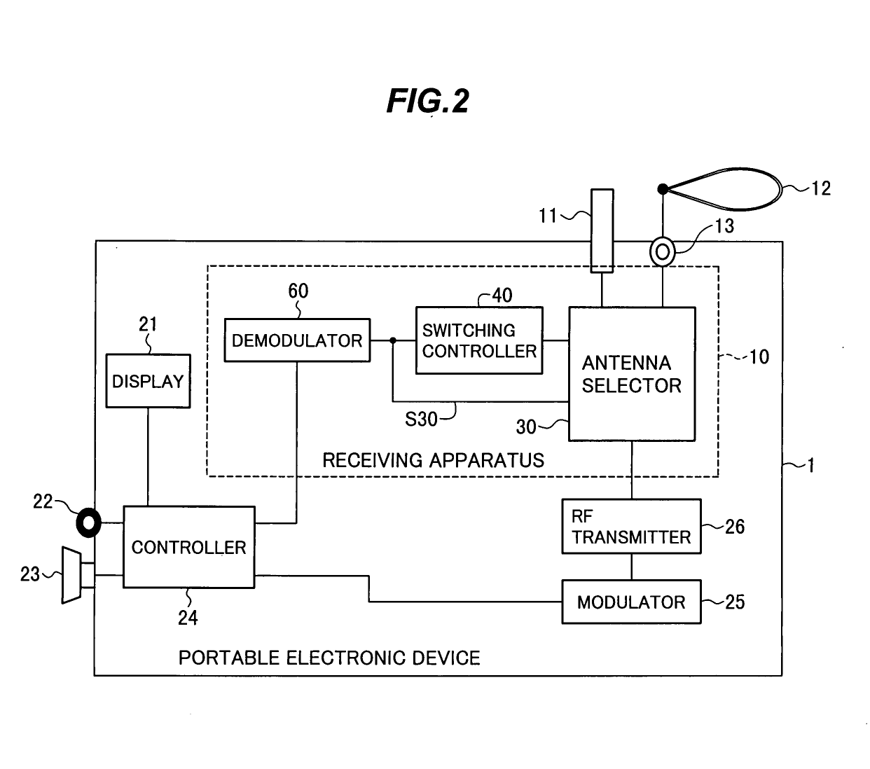

Referring to FIGS. 1 and 2, the portable electronic device 1 is a telephone having a detachable neckstrap that can be worn around the user's neck. A first antenna 11 is built into the main body of the portable telephone, and a second antenna 12 is embedded in the neckstrap. The main body also has an external antenna connector 13 to which the second antenna 12 is detachably connected.

The portable electronic device 1 includes the receiving apparatus 10, a display 21, a microphone 22, a loudspeaker 23, a controller 24, a modulator 25, and a high-frequency transmitter, referred to below as a radio-frequency (RF) transmitter 26. The receiving apparatus 10 includes an antenna selector 30, a switching controller 40, and a demodulator 60.

During transmission, the controller 24 converts input signals from, for example, the microphone 22 to successive packets of digital data, and sends the packets to the modulator 25. The modulator 25 modulates the packet data received from the controller 24 onto an intermediate-frequency signal, and sends the modulated intermediate-frequency signal to the radio-frequency transmitter 26. The radio-frequency transmitter 26 modulates the signal received from the modulator 25 onto a carrier signal to generate a transmit signal, which is supplied to the antenna selector 30. The antenna selector 30 sends the transmit signal to the first antenna 11 and/or the second antenna 12.

During reception, the antenna selector 30, receives a signal S11 from the first antenna 11, receives a signal S12 from the second antenna 12 via the external antenna connector 13, selects one or both of these signals S11, S12, and converts the selected signal(s) to an intermediate-frequency received signal S30, which is supplied to the switching controller 40 and demodulator 60. The switching controller 40 sends antenna selection signals to the antenna selector 30. The demodulator 60 demodulates the intermediate-frequency received signal S30 to generate packet data, and sends the packet data to the controller 24. The controller 24 converts the packet data to, for example, a voice signal that is reproduced through the loudspeaker 23. The controller 24 also controls the display 21.

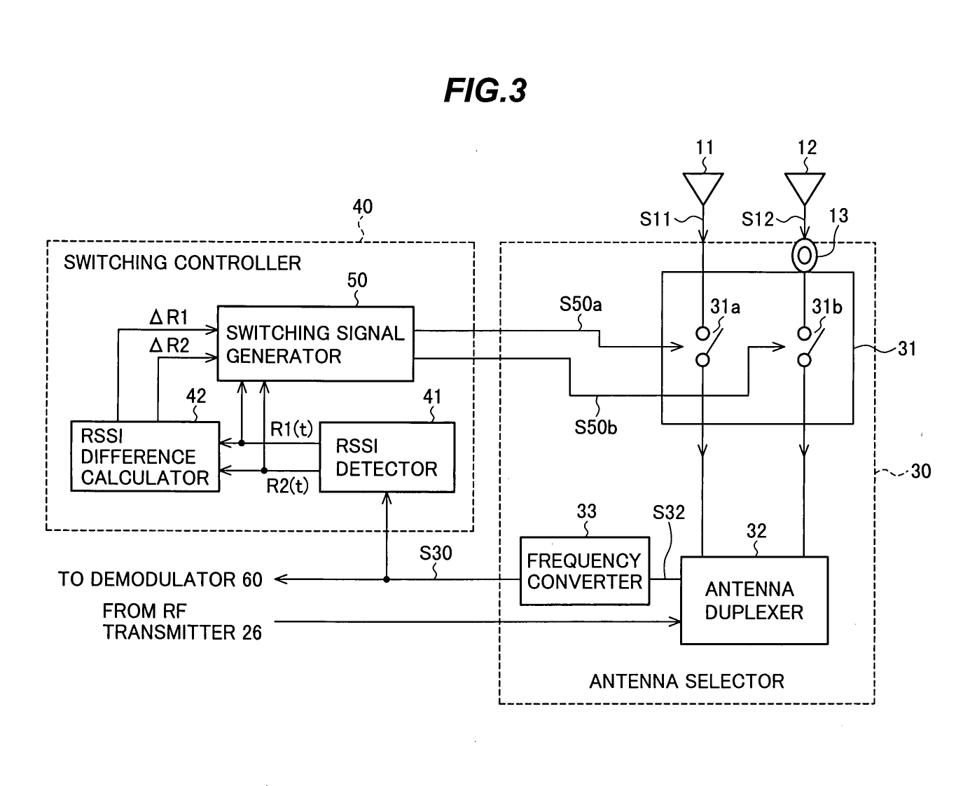

Referring to FIG. 3, the receiving apparatus 10 includes an antenna switch 31, an antenna duplexer 32, and a frequency converter 33. The antenna switch 31 includes a pair of switches 31a and 31b that receive signals S11, S12, respectively, from the first and second antennas 11, 12, and supply these signals selectively to the antenna duplexer 32. The switches 31a, 31b are switched on and off by respective switching signals S50a, S50b from the switching controller 40. The antenna duplexer 32 combines whichever signal or signals S11, S12 it receives from the antenna switch 31 into an RF received signal S32, which is sent to the frequency converter 33. The frequency converter 33 amplifies the RF received signal S32 and down-converts it to obtain the intermediate-frequency received signal S30 that is supplied to the switching controller 40 and demodulator 60.

During transmission, the antenna duplexer 32 also receives the transmit signal from the radio-frequency transmitter 26 and outputs it through the antenna switch 31 to the selected antenna or antennas 11, 12.

The switching controller 40 is implemented as a computing device with a central processing unit (not shown) executing a program stored in a storage device (not shown). The functional units of the switching controller 40 include a received signal strength detection means such as, for example, a received signal strength indication (RSSI) detector 41, a RSSI difference calculator 42, and a switching signal generator 50.

The RSSI detector 41 detects the RSSI values of the first and second antennas 11, 12 and sends the detected values as signals R1(t) and R2(t) to the RSSI difference calculator 42. R1(t) represents the RSSI value of the signal S11 received by the first antenna 11 and R2(t) represents the RSSI value the signal S12 received by the second antenna 12.

The RSSI difference calculator 42 receives and stores RSSI values R1(t), R2(t) and calculates the difference between present and past RSSI values. For example, if the RSSI difference calculator 42 receives RSSI values R1(t1) and R2(t1) detected at a time t1 after having received and stored previous RSSI values R1(t2), R2(t2) detected at a past time t2, it reads the stored values R1(t2), R2(t2) and calculates two difference values ΔR1 and ΔR2 by the following equations (1) and (2).

ΔR1=R1(t1)−R1(t2) (1)

ΔR2=R2(t1)−R2(t2) (2)

The switching signal generator 50 receives the RSSI values R1(t), R2(t) from the RSSI detector 41 and the difference values ΔR/, ΔR2 from the RSSI difference calculator 42, and outputs the switching signals S50a, S50b to the antenna switch 31 in the antenna selector 30.

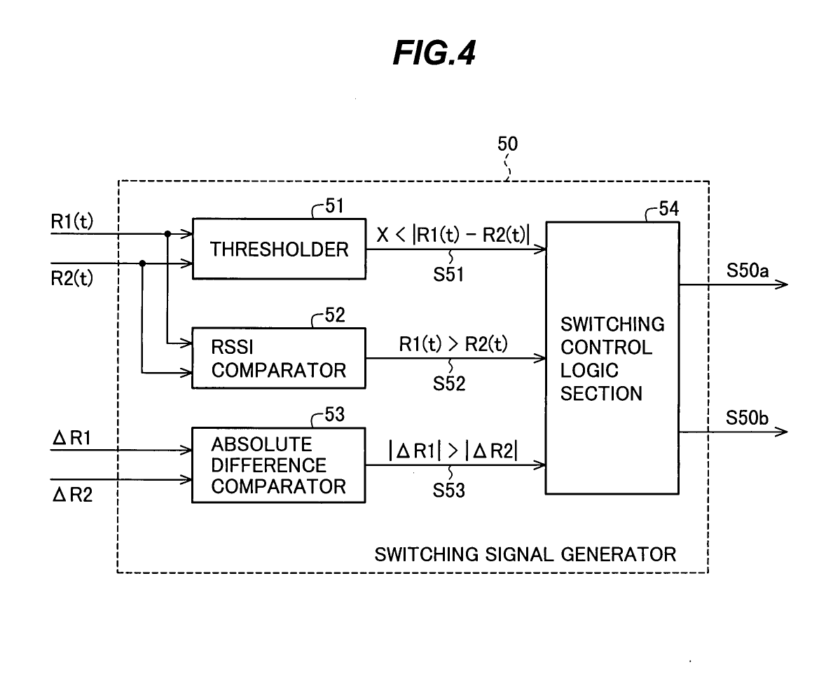

Referring to FIG. 4, the switching signal generator 50 comprises a thresholder 51, an RSSI comparator 52, an absolute difference comparator 53, and a switching control logic section 54.

The thresholder 51 receives the RSSI values R1(t), R2(t), compares the absolute value of the difference between them with a threshold value X, and outputs the result as a signal S51 with a binary value of ‘1 ’ or ‘0 ’ indicating whether the absolute difference exceeds the threshold value.

The RSSI comparator 52 compares RSSI value R1(t) with RSSI value R2(t) and outputs the result as a signal S52 with a binary value of ‘1 ’ or ‘0 ’ indicating whether R1(t) exceeds R2(t), that is, R1(t)>R2(t); a value of ‘0 ’ indicates that R1(t) does not exceed R2(t).

The absolute difference comparator 53 compares the absolute value of the difference ΔR1 with the absolute value of the difference ΔR2 and outputs the result as a signal S53 with a binary value of ‘1 ’ or ‘0 ’ indicating whether absolute difference |ΔR1| exceeds absolute difference |ΔR2|.

The switching control logic section 54 receives the signals S51, S52, S53 output from the thresholder 51, RSSI comparator 52, and absolute difference comparator 53 and performs a logic operation that generates the switching signals S50a, S50b that control the switches 31a, 31b.

The operation of the receiving apparatus 10 will now be described in more detail. First, the general operation of the portable electronic device 1 will be summarized. It will be assumed that the neckstrap shown in FIGS. 1 and 2 is worn around the user's neck and that the second antenna 12 embedded in the neckstrap is connected to the external antenna connector 13 of the portable electronic device 1.

The controller 24 of the portable electronic device 1 generates packets based on input from, for example, the microphone 22. The packet signals are modulated onto the intermediate-frequency transmit signal by the modulator 25, and then onto the transmitted carrier signal by the radio-frequency transmitter 26 to create a transmit signal, which is transmitted from the antenna or antennas selected by the antenna selector 30 in the receiving apparatus 10.

In the receiving apparatus 10, the antenna selector 30 selects the antennas 11, 12 according to their RSSI values and various differences thereamong, and outputs the received signal S30 to the switching controller 40 and the demodulator 60. The demodulator 60 demodulates the received signal S30 to generate packet data. The controller 24 converts the packet data to, for example, a voice signal for output to the loudspeaker 23.

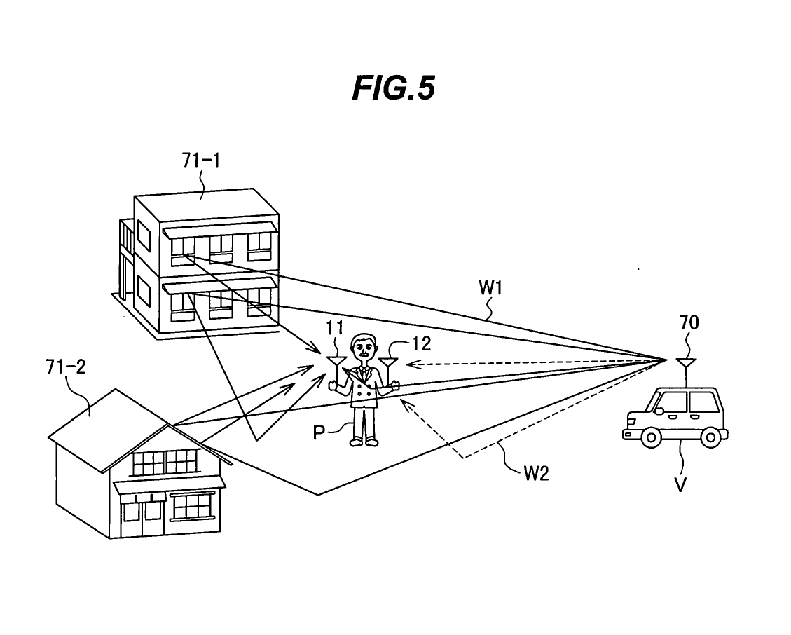

Next, the basic idea of antenna selection will be described with reference to FIG. 5.

In FIG. 5, a strongly directional radio signal is transmitted from an antenna 70 mounted on a vehicle V. The radio signal is received by the first and second antennas 11, 12 of the portable electronic device 1, which is held by a person P. The person P is standing with his back to the transmitting antenna 70, and is holding the portable electronic device 1 in his hand in front of him. Accordingly, the first antenna 11 is positioned in front of the person P and the second antenna 12, which is embedded in the neckstrap, is partly in back of the person P.

The radio signal transmitted from the antenna 70 includes radio waves W1, shown by solid lines, that propagate on paths reflected by buildings 71-1, 71-2 and are received by the first antenna 11, and radio waves W2, indicated by dashed lines, that propagate along a direct path or a path reflected on a road surface and are received by the second antenna 12.

In FIG. 3, the antenna selector 30 obtains the received signal S30 from the signals S11, S12 received by the first and second antennas 11, 12. The RSSI detector 41 detects the RSSI values of signals S11 and S12 from the received signal S30. The RSSI values are detected at specific timings in the packets that make up the received signal S30.

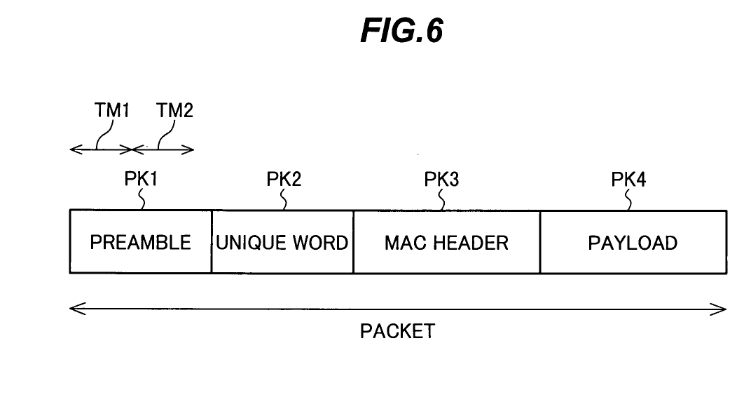

FIG. 6 shows the schematic structure of these packets. Each packet includes an initial non-data interval referred to as a preamble PK1, followed by a unique word interval PK2, a media access control (MAC) header interval PK3, and a payload interval PK4, all of which include data. The RSSI values R1(t), R2(t) are detected in respective subintervals TM1, TM2 within the preamble interval PK1. The preamble interval PK1 is short enough that while the preamble is being received, only negligible signal propagation path variations occur due to the movement of the transmitting and receiving antennas, so both subintervals TM1, TM2 are regarded as representing the same time t.

The total length of the preamble interval is also much shorter than the packet length, and is therefore much shorter than the interval (t1-t2) between present and past RSSI measurements.

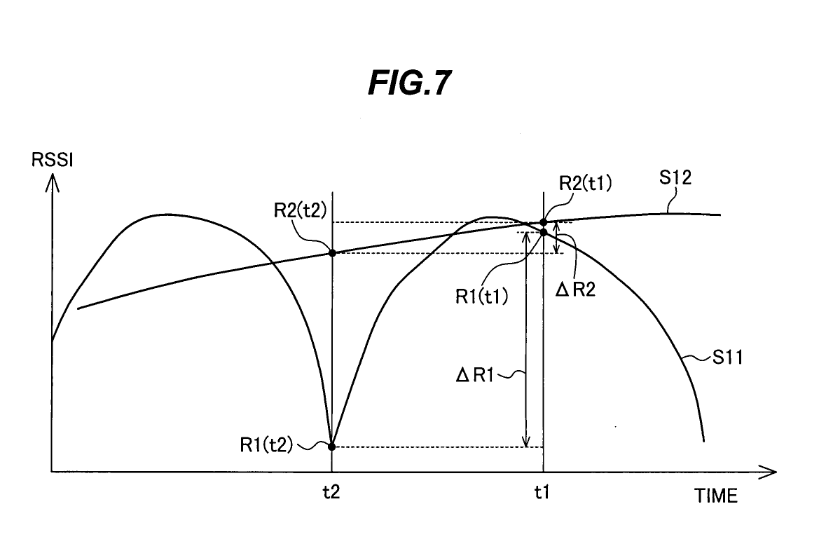

FIG. 7 shows exemplary variations of the RSSI values over a longer span of time, including a present time t1 and at a past time t2 at which the RSSI values are detected by the RSSI detector 41. There is little difference between the RSSI values R1(t1), R2(t1) detected at the present time t1, providing little basis for choosing between the two antennas. However, there is a large difference between the RSSI values R1(t2), R2(t2) detected at the past time t2, so a meaningful antenna selection can be made by comparing the RSSI difference values ΔR1, ΔR2.

To investigate the effect of human body interference on reception, the inventors performed a simulated communication quality evaluation on the basis of best-case and worst-case delay profiles derived from radio wave propagation simulations and from propagation experiments in environments in which portable electronic devices are commonly used. The quantity evaluated was the relationship between the carrier-to-noise ratio (CNR) and the packet error rate (PER). Fading increases from the best-case delay profile to the worst-case delay profile.

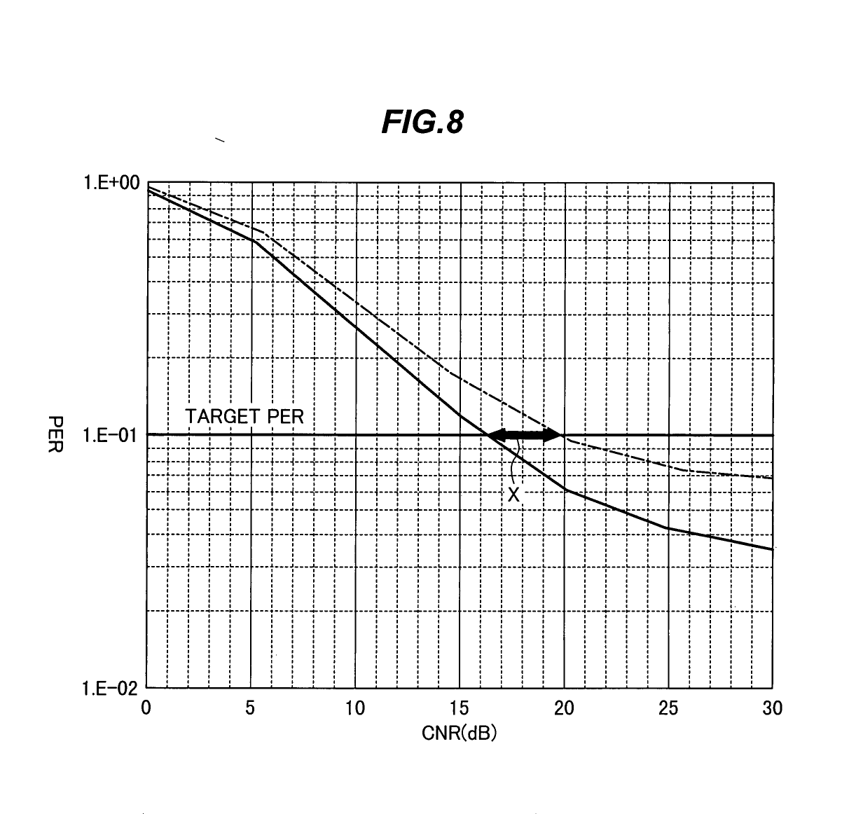

The CNR versus PER relationships for the best-case and worst-case delay profiles are shown by the graph in FIG. 8. The vertical axis represents PER and the horizontal axis represents CNR. The PER-to-CNR relationship under the best-case delay profile is shown by the solid curve; the PER-to-CNR relationship under the best-case delay profile is shown by the dot-dash curve. The PER value (1.E-01, meaning 10⁻¹) indicated by the solid horizontal line is the target packet error rate of the portable electronic device 1. The CNR difference between the best- and worst-case delay profiles corresponding to this target PER is set as the threshold strength difference X.

‘Target’ means that the portable electronic device 1 is designed to operate at packet error rates substantially equal to or less than the target rate.

The actual delay profiles of the signals S11, S12 received by the first and second antennas will in general lie between the best-case and worst-case curves in FIG. 8. There is a tendency for the second antenna 12 to produce a delay profile closer to the best-case delay profile, because it is less susceptible to human body interference, and for the first antenna 11 to produce a profile closer to the worst-case profile, because it is more susceptible to human body interference. Regardless of which antenna has the better delay profile, however, if the difference between the carrier-to-noise ratios, which corresponds to the difference between the RSSI values, is less than X, then a lower packet error rate is generally obtained by selecting the antenna with the better delay profile, instead of the antenna with the better CNR value. That is, the better PER value is obtained by selecting the antenna with less fading, as indicated by the difference values ΔR1, ΔR2, instead of selecting the antenna having the larger RSSI value.

In one embodiment of the invention, when the difference between the RSSI values of the first and second antennas 11, 12 is less than the threshold value X, the antenna having the smaller difference between past and present RSSI values is selected. If the difference between the RSSI values of the first and second antennas 11, 12 is greater than the threshold value X, then the antenna having the larger RSSI value is selected.

Next, the general operation of the receiving apparatus 10 will be summarized.

The antenna selector 30 switches the antenna signals S11, S12 so that during the reception of a packet preamble at a time t1, the received signal S30 output from the antenna selector 30 represents first the signal S11 received by the first antenna 11, and then the signal S12 received by the second antenna 12.

The RSSI detector 41 detects the RSSI value R1(t1) for the first antenna 11 and the RSSI value R2(t1) for the second antenna 12 at this time t1. The RSSI difference calculator 42 calculates the difference values ΔR1, ΔR2 between these RSSI values R1(t1), R2(t1) and corresponding RSSI values R1(t2), R2(t2) detected at a past time t2 at which the preamble of the preceding packet was received, using the above equations (1), (2). The switching signal generator 50 uses the detected RSSI values R1(t1), R2(t1) and the calculated difference values ΔR1, ΔR2 to generate switching signals S50a, S50b that control the antenna switch 31 so as to select the best antenna for receiving the transmitted signal in the interval following time t1.

Next, a more detailed description of the operation of the receiving apparatus 10 will be given.

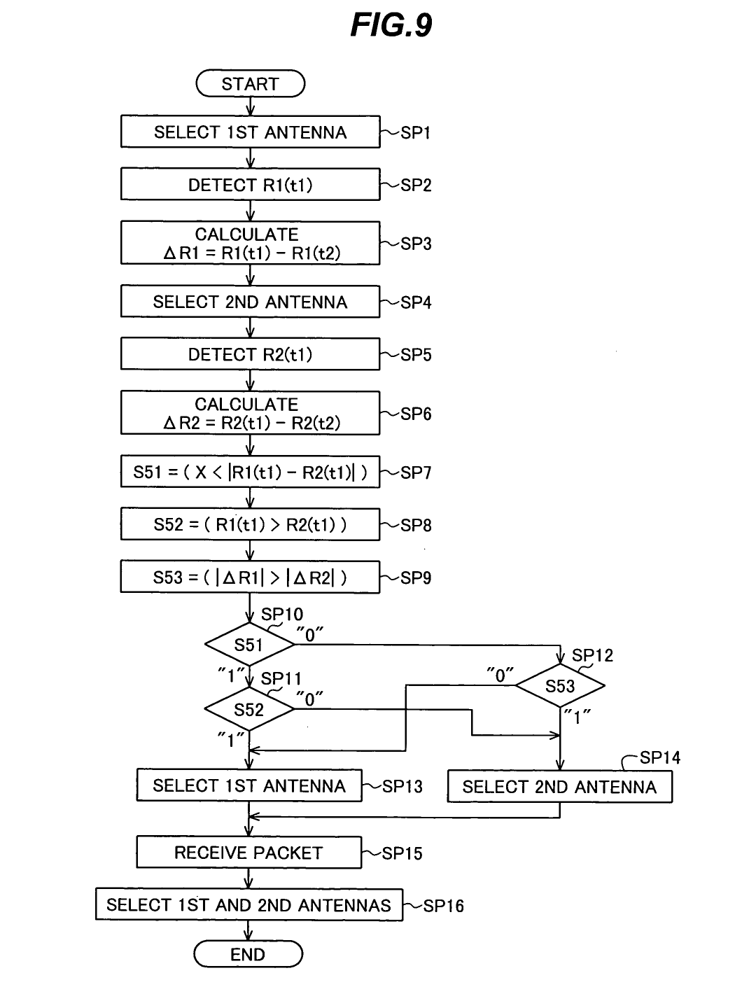

Before packet reception begins, the switching signals S50a, S50b set both switches 31a, 31b to the on state, and the antenna selector 30 outputs a received signal in which the signals S11, S12 received by the two antennas 11, 12 are combined. When the preamble PK1 of a packet is detected, the first RSSI detection interval TM1 starts immediately and switching control proceeds as shown in the flowchart in FIG. 9.

In this processing flow, steps SP1 and SP4 are antenna switching steps executed by the switching signal generator 50 and antenna switch 31, steps SP2 and SP5 are received signal strength detection steps executed in the RSSI detector 41, and steps SP3 and SP6 are RSSI difference calculation steps executed in the RSSI difference calculator 42.

In step SP1, the antenna switch 31 selects the first antenna 11 and the processing flow proceeds to step SP2. In step SP2, the RSSI detector 41 detects the RSSI value R1(t1) from the received signal S30 and the processing flow proceeds to step SP3. In step SP3, the RSSI difference calculator 42 stores the received RSSI value R1(t1) and calculates the difference ΔR1 between R1(t1) and the RSSI value R1(t2) stored at a past time t2 when the preceding packet was received. The processing flow then proceeds to step SP4 and the second RSSI detection interval TM2 begins.

In step SP4, the antenna switch 31 selects the second antenna 12 and the processing flow proceeds to step SP5. In step SP5, the RSSI detector 41 detects the RSSI value R2(t1) from the received signal S30 and the processing flow proceeds to step SP6. In step SP6, the RSSI difference calculator 42 stores the received RSSI value R2(t1) and calculates the difference ΔR2 between R2(t1) and the RSSI value R2(t2) stored at the past time t2, using the above equation (2). The TM2 interval terminates in step SP6, and the processing flow proceeds to step SP7.

Steps SP7 to SP14 are switching processing steps executed in the switching signal generator 50.

In step SP7, the thresholder 51 takes the absolute value |R1(t1)−R2(t1)| of the difference between RSSI values R1(t1) and R2(t1), compares this absolute value with the threshold value X, and determines whether the following condition is satisfied.

X<|R1(t1)−R2(t1)| (3)

If condition (3) is satisfied, signal S51 is set to ‘1 ’; otherwise, signal S51 is set to ‘0 ’. The processing then proceeds to step SP8, in which the RSSI comparator 52 compares RSSI value R1(t1) with RSSI value R2(t1). If the condition R1(t1)>R2(t1) is satisfied, signal S52 is set to ‘1 ’; otherwise signal S52 is set to ‘0 ’. The processing now proceeds to step SP9, in which the absolute difference comparator 53 compares the absolute value of the difference value ΔR1 with the absolute value of the difference value ΔR2. If the condition |ΔR1|>|ΔR2| is satisfied, signal S53 is set to ‘1 ’; otherwise, signal S53 is set to ‘0 ’. The processing then proceeds to steps SP10 to SP14, which are executed by the switching control logic section 54.

In step SP10, if signal S51 is ‘1 ’, the processing flow proceeds to step SP11; if signal S51 is ‘0 ’, the processing flow branches to step SP12. In step SP11, if signal S52 is ‘1 ’, the processing flow proceeds to step S13; if signal S52 is ‘0 ’, the processing flow proceeds to step S14. In step SP12, if signal S53 is ‘1 ’, the processing flow proceeds to step S14; if signal S53 is ‘0 ’, the processing flow proceeds to step S13. In step SP13, the switching control logic section 54 outputs switching signals S50a, S50b that turn switch 31a on and switch 31b off, thereby selecting the first antenna 11, and the processing flow proceeds to step SP15. In step SP14, the switching control logic section 54 outputs switching signals S50a, S50b that turn switch 31a off and switch 31b on, thereby selecting the second antenna 12, and the processing flow proceeds to step SP15.

In step SP15, the packet data are received by demodulating the received signal S30, which represents the signal received by the selected antenna. At the completion of reception of the packet, the processing proceeds to step SP16, in which the switching signals 50a, 50b turn on both switches 31a and 31b, returning the antenna selector 30 to the initial state before step SP1: both antennas are selected and their signals S11, S12 are combined. In this state the receiving apparatus 10 awaits the arrival of the next packet.

The following advantages are obtained from the receiving apparatus described above.

Because the receiving apparatus has both an RSSI detector for detecting RSSI values and an RSSI difference calculator for calculating differences between present and past RSSI values, the antennas can be selected not only according to their relative received signal strengths but also according to the amount of fading they are experiencing. This makes it possible to reduce the packet error rate by avoiding the use of an antenna that, because of human body interference, is receiving mainly reflected waves, which tend to produce pronounced fading, and instead to select the other antenna, which has less fading.

Because antenna switching occurs only in the initial non-data preamble of a packet, antenna switching does not produce bit errors due to switching noise or disturbance of phase relationships during demodulation. Moreover, since the preamble immediately precedes the data sections of the transmitted packet, the difference between the RSSI values in the preamble and the RSSI values during the data sections is small.

Because the threshold value with which the difference between the two present RSSI values are compared is derived from the target packet error rate of the receiving apparatus, the antenna selection logic can be optimized to produce the best antenna selection in the vicinity of the target packet error rate, where antenna selection is most critical and it is most important to avoid the effects of human body interference.

When the receiving apparatus is used in a portable electronic device such as a portable telephone, these advantages produce the following effects.

The user of the portable electronic device can obtain good reception regardless of the positional relationship of the portable electronic device to the user's body, because even if the portable electronic device is held in a position that produces considerable fading at one of the antennas, the other antenna will be selected, provided its received signal strength is not too much lower. If the portable electronic device is a portable telephone that the user is using while moving around, the result is improved voice communication quality.

Even if the user moves frequently or the radio wave propagation environment changes in a way that leads to frequent antenna switching, since the antennas are not switched in the data intervals of the received packets, bit errors due to antenna switching during demodulation are avoided, which also improves communication quality.

Since the threshold value X is based on the target packet error rate of the portable electronic device, the antennas are switched in a way that maintains an acceptable packet error rate, and the user does not experience drastic degradation of communication quality due to human body interference.

The invention is not limited to the above embodiment. The following are some of the possible variations.

The structure of the receiving apparatus 10 may differ from the structure shown in FIG. 3, and the processing flow may differ from the flow shown in FIG. 8.

The times at which the RSSI values are detected need not be confined to packet preambles. RSSI values may be detected in the unique word interval or any interval other than the packet payload interval.

The time t2 at which the past RSSI values used for calculating the differences ΔR1, ΔR2 are detected is not limited to the time of arrival of the preceding packet. RSSI values may be detected at substantially fixed intervals determined in consideration of the radio signal propagation environment, such as, for example, intervals of about ten milliseconds.

The threshold value X may be calculated as the amount by which the CNR value may change without causing more than, for example, a ten-percent change from the target packet error rate, instead of being calculated from the difference between the best- and worst-case delay profiles.

The two antennas may be any two antennas that are differently affected by human body interference and accordingly produce different delay profiles. For example, the first antenna may be built into the portable electronic device and the second antenna may be embedded in an earphone cord, instead of a neckstrap, or both antennas may be external antennas connected to the portable electronic device by separate external antenna connectors.

It is not necessary for the same antennas to be used for both transmitting and receiving as in the embodiment described above. One or more transmitting antennas may be provided separately from the receiving antennas.

If necessary, RF receiving amplifiers may be inserted between the first and second antennas and the antenna switch to compensate for cable loss on the paths from the first and second antennas to the antenna duplexer and power loss in the antenna duplexer. If these RF receiving amplifiers provide adequate amplification, the frequency converter can be removed from the antenna selector and the RF received signal S32 may be supplied to the switching controller.

Those skilled in the art will recognize that further variations are possible within the scope of the invention, which is defined in the appended claims.

What is claimed is:

1. A receiving method employing a first antenna receiving a transmitted signal and outputting a first received signal, a second antenna receiving the transmitted signal and outputting a second received signal, the second antenna being spatially separated from the first antenna, and a selector controlled by a switching signal to select the first received signal and/or the second received signal and output the selected signal(s), the method comprising:
selecting a first timing interval and a second timing interval in the transmitted signal, the second timing interval preceding the first timing interval;
measuring a received signal strength of the first received signal in the first timing interval to obtain a first received signal strength, and in the second timing interval to obtain a first past received signal strength;
measuring a received signal strength of the second received signal in the first timing interval to obtain a second received signal strength, and in the second timing interval to obtain a second past received signal strength;
calculating a first difference between the first received signal strength and the first past received signal strength;
calculating a second difference between the second received signal strength and the second past received signal strength; and
generating the switching signal according to the first received signal strength, the second received signal strength, the first difference, and the second first difference.

2. The receiving method of claim 1, wherein the transmitted signal is directional.

3. The receiving method of claim 1, wherein the first received signal strength and the second received signal strength are measured in different subintervals of the first interval.

4. The receiving method of claim 1, wherein the first interval and the second interval have a predetermined length.

5. The receiving method of claim 4, wherein the first interval and the second interval are mutually separated by a length of time longer than said predetermined length.

6. The receiving method of claim 1, wherein the transmitted signal is a packet signal and the first interval and the second interval are located in different packets.

7. The receiving method of claim 6, wherein the transmitted signal is a packet signal and the first interval and the second interval are located in preambles of the different packets.

8. The method of claim 1, wherein generating the switching signal further comprises:
subtracting the second received signal strength from the first received signal strength to obtain a third difference;
subtracting an absolute value of the second difference from an absolute value of the first difference to obtain a fourth difference;
selecting the first received signal if an absolute value of the third difference is greater than a threshold value and the third difference is positive;
selecting the second received signal if the absolute value of the third difference is greater than the threshold value and the third difference is negative;
selecting the first received signal if the absolute value of the third difference is less than the threshold value and the fourth difference is negative; and
selecting the second received signal if the absolute value of the third difference is less than the threshold value and the fourth difference is positive.

9. The receiving method of claim 8, wherein the transmitted signal is transmitted on a carrier signal, the receiving method further comprising:
calculating a first carrier-to-noise ratio of the carrier signal corresponding to a target packet error rate under a worst-case delay profile of the carrier signal;
calculating a second carrier-to-noise ratio of the carrier signal corresponding to the target packet error rate under a best-case delay profile of the carrier signal; and
setting the threshold value according to a difference between the first carrier-to-noise ratio and the second carrier-to-noise ratio.

10. A receiving apparatus comprising:
a first antenna receiving a transmitted signal and outputting a first received signal;
a second antenna receiving the transmitted signal and outputting a second received signal, the second antenna being spatially separated from the first antenna;
a selector controlled by a switching signal to select the first received signal and/or the second received signal and output the selected signal(s);
a received signal strength detector for selecting a first timing interval and a second timing interval in the transmitted signal, the second timing interval preceding the first timing interval, measuring a received signal strength of the first received signal in the first timing interval to obtain a first received signal strength and in the second timing interval to obtain a first past received signal strength, and measuring a received signal strength of the second received signal in the first timing interval to obtain a second received signal strength, and in the second timing interval to obtain a second past received signal strength;
a difference calculator for calculating a first difference between the first received signal strength and the first past received signal strength, and calculating a second difference between the second received signal strength and the second past received signal strength; and
a switching signal generator for generating the switching signal according to the first received signal strength, the second received signal strength, the first difference, and the second first difference.

11. The receiving apparatus of claim 10, wherein the transmitted signal is directional.

12. The receiving apparatus of claim 10, wherein the first received signal strength and the second received signal strength are measured in different subintervals of the first interval.

13. The receiving apparatus of claim 10, wherein the first interval and the second interval have a predetermined length.

14. The receiving apparatus of claim 13, wherein the first interval and the second interval are mutually separated by a length of time longer than said predetermined length.

15. The receiving apparatus of claim 10, wherein the transmitted signal is a packet signal and the first interval and the second interval are located in different packets.

16. The receiving apparatus of claim 15, wherein the transmitted signal is a packet signal and the first interval and the second interval are located in preambles of the different packets.

17. The receiving apparatus of claim 10, wherein the switching signal generator subtracts the second received signal strength from the first received signal strength to obtain a third difference, subtracts an absolute value of the second difference from an absolute value of the first difference to obtain a fourth difference, selects the first received signal if an absolute value of the third difference is greater than a threshold value and the third difference is positive, selects the second received signal if the absolute value of the third difference is greater than the threshold value and the third difference is negative, selects the first received signal if the absolute value of the third difference is less than the threshold value and the fourth difference is negative, and selects the second received signal if the absolute value of the third difference is less than the threshold value and the fourth difference is positive.

18. The receiving apparatus of claim 17, wherein the transmitted signal is transmitted on a carrier signal and the threshold value indicates a difference between a first carrier-to-noise ratio of the carrier signal corresponding to a target packet error rate under a worst-case delay profile of the carrier signal, and a second carrier-to-noise ratio of the carrier signal corresponding to the target packet error rate under a best-case delay profile of the carrier signal.
